(19) United States
(12) Patent Application Publication
(10) Pub. No.: US 2009/0210312 A1
(43) Pub. Date: Aug. 20, 2009

(54) ON-LINE FACILITY FOR FINANCIAL TRANSACTIONS

(75) Inventors: Colin Lionel Frey, London (GB); Stephen John Martyn, London (GB)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: Safetrade Limited, Hertfordshire (GB)

(21) Appl. No.: 12/034,246

(22) Filed: Feb. 20, 2008

(51) Int. Cl. G06Q 30/00

(52) U.S. Cl. 705/26

(57) ABSTRACT

A computerised transaction management system is described. The system provides a secure process for conducting a financial transaction between buyer and seller, enabling them to negotiate price and accept or reject goods remotely or in person, in real time. It also holds any funds securely until the transaction has been agreed. The invention provides a uniquely interactive system to manage and control any number of transactions within the security of a user's own home.

### BACKGROUND

1. Field of the Invention

The present invention relates to a computerised method and system for conducting financial transactions, in particular transactions relating to items of tangible property that are for sale, such as goods and specifically vehicles.

2. Related Art

Conventional methods of conducting a transaction leave the buyer vulnerable to loss and theft, especially at the moment payment is made. Such dangers are most readily illustrated by means of an example from the sale and purchase of vehicles.

Typically, a buyer on seeing an advertised vehicle will make arrangements to view it. If a price is agreed at the viewing, the buyer and seller will then decide on a payment method and if necessary make a follow-up appointment for the buyer to collect the vehicle and take ownership. The buyer has two options for payment. Cash allows collection to be made immediately, if desired, but is risky given the necessity for the buyer to carry the money about their person where it might be lost or stolen. On the other hand, payment methods that require money to be transferred into a bank account, such as cheques or bank electronic transfers introduce a time delay and mean that the buyer can no longer be certain that they will receive the same goods, goods that are in the same condition as originally agreed upon, or receive the goods at all. In the case of vehicles for example, it is not uncommon for the seller to continue using the vehicle without the agreement of the buyer and with the risk of it being damaged.

Trusting the other party in a transaction is a constant risk. As noted above, a seller who continues to use an item up to the moment collection is made is just one of the risks faced by the buyer. A more extreme possibility, is a dishonest seller who may either steal the cash carried by the buyer, or once payment has been received, disappear or substitute a different item to the one offered. There are similar risks posed to the seller, although these are usually solely to do with securing payment from the buyer and so are more easily avoided.

Nowadays, many sellers choose to place their advertisements and offers for sale on the Internet rather than use more traditional channels such as magazines and newspapers. E-Bay, is an extremely successful auction web site that allows sellers to post offers relating to items for sale and buyers to respond by placing bids within an allotted period of time. A payment facility, in this case PayPal, is subsequently used to arrange payment between a buyer and the seller once a bid has been accepted. On-line web sites such as E-bay allow buyers and sellers from all over the world to conduct transactions with each other, providing a truly diverse and open market place. Long distance selling of this kind, however, raises a number of problems similar to the scenario described above.

Current payment or transaction systems, for example, PayPal, favour the seller and leave the buyer vulnerable, because payment is made in advance of inspecting goods and is based on the seller's written description or photograph. The transaction is therefore based on trust that the goods will match the seller's description, and that the goods will arrive. Currently, a buyer's decision to trust a seller may be based on a resume of the seller's transaction history published on the web site, but such resumes are often inaccurate.

The time and cost involved in resolving disputes over goods is a major source of dissatisfaction among traders on the Internet. Credit card companies and banks have done very little to address the underlying problems, and insurance, where provided very often fails to meet the full cost of the goods disputed or lost.

One prior art system that provides at least some protection for traders on the internet is the escrow process. In a trading context, escrow is a legal process in which a third party receives funds from the buyer and holds these in trust until the buyer has received the goods from the seller and confirmed that the goods and the quality of the goods meet any agreed criteria. The process is illustrated in more detail in FIG. 1.

First, the buyer and seller must be in agreement (step 2) to use an escrow process, and on the terms and conditions of the sale. Terms and conditions includes what the goods are, the quality of the goods (e.g. new, used, first edition etc.), the price, the payment method, and other details, such as who is liable for postage and shipping costs, initially and for any returns, who bears the cost of any insurance, time limits and so on. Having chosen an escrow service (step 2), the buyer then forwards payment for the agreed price to the service (step 4). Example on-line escrow services are known, such as Escrow.com and Escrow Europa.

Once the escrow service has received the funds from the buyer it will forward to the seller a notification of this fact, and request that the seller ship the agreed goods to the buyer (step 6). All being well, the buyer receives the goods (step 8) and can inspect them before the transaction is completed. If the goods are satisfactory, then the buyer notifies the escrow service (step 8) and the escrow service releases the funds to the seller (step 10). If the goods are not satisfactory, then the buyer returns the goods to the seller, and receives from the escrow service a refund, less any costs incurred in the transaction so far.

Although, disputes between the buyer and seller are left up to the parties to resolve, the escrow service process provides both buyer and seller with some guarantees. However, the escrow process depends upon the terms and conditions agreed at the outset, and there is no room for negotiation later in the process. If renegotiation were desired, a new escrow would need to be set up, incurring fees and inconvenience.

We have appreciated that there is a need for an improved computerised, on-line facility for making financial transactions that addresses the many problems identified above.

### SUMMARY

The invention is defined in the independent claims to which reference should now be made. Advantageous features are set forth in the dependent claims.

The invention provides a secure process of financial transaction connecting buyer and seller, enabling them to negotiate price and accept or reject goods remotely or in person, in real time. It also holds any funds securely until the transaction has been agreed. The invention provides a uniquely interactive system to manage and control any number of transactions within the security of a user's own home.

### BRIEF DESCRIPTION OF THE FIGURES

FIG. 1. is a flow chart illustrating a prior art escrow process;

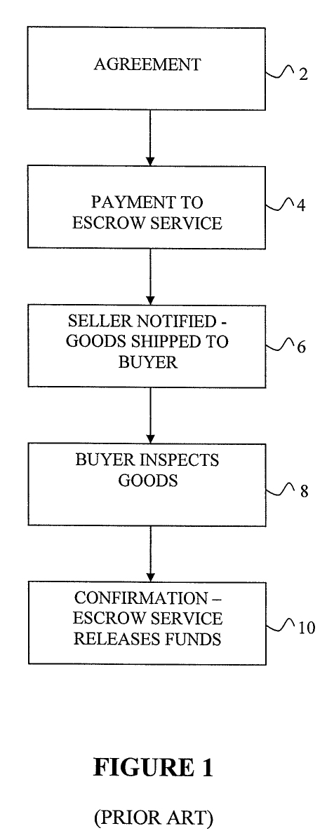

FIG. 2. is a flow chart illustrating an example financial transaction process according to the invention;

FIG. 3. is a flow chart illustrating in more detail the example financial transaction process according to the invention;

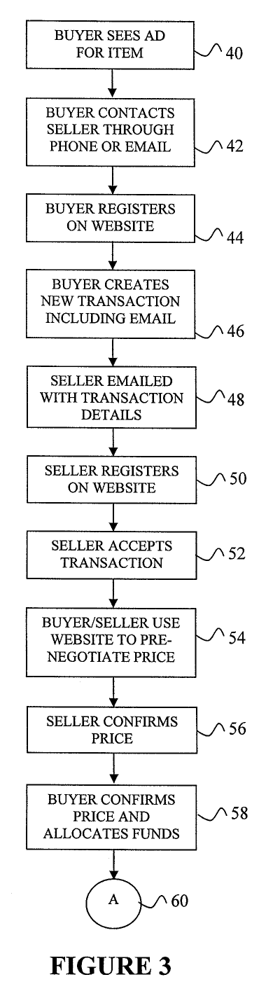

FIG. 4. is a flow chart illustrating in more detail the example process for a Postal type transaction;

FIG. 5. is a flow chart illustrating in more detail the example process for a Face-to-Face type transaction; and

FIG. 6. is a schematic diagram illustrating in more detail the transaction system according to an example implementation of the invention.

### DETAILED DESCRIPTION

The following description is provided so that the person skilled in the art can make and use the invention, and therefore discloses particular examples for ease of understanding. However, various modifications to the examples disclosed will be readily apparent to those skilled in the art. The general principles defined herein may be applied to other embodiments and applications without departing from the spirit and scope of the present invention as defined by the claims. It is not intended that the present invention be limited to the embodiments shown. Instead, it should be accorded the widest scope consistent with the principles and features disclosed herein.

The data structures and code described in this detailed description are typically stored on a computer readable storage medium, which may be any device or medium that can store code and/or data for use by a computer system. This includes, but is not limited to electronic, magnetic and optical storage devices such as computer memory devices, portable or otherwise, disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

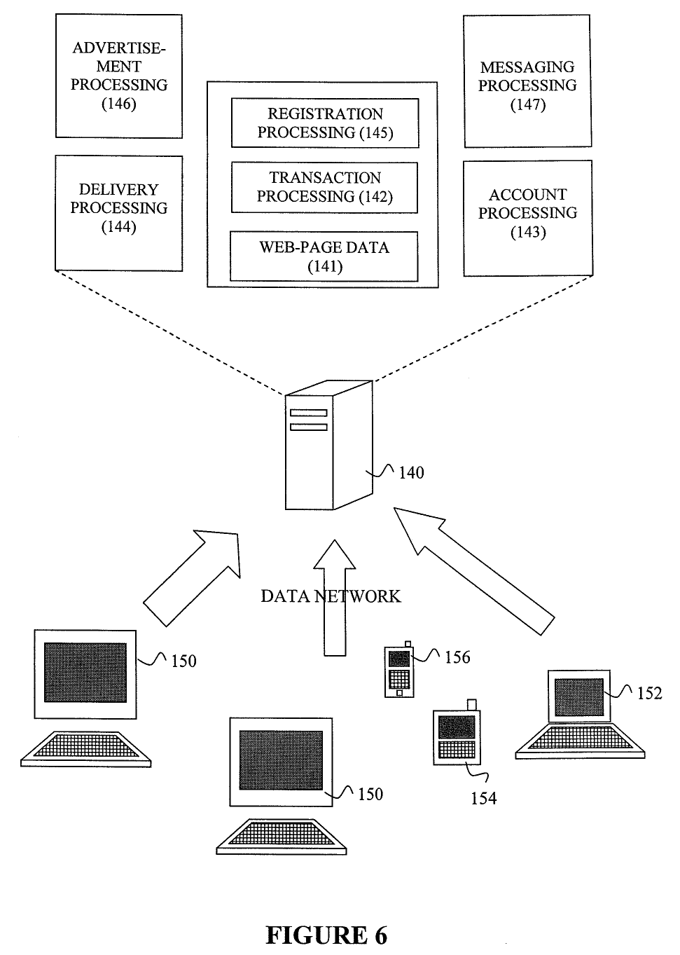

An example embodiment of the invention will now be described with reference to FIG. 6. The example embodiment includes a computer or server 140 hosting a web site 141 for facilitating transactions between parties. The web site is accessible via the Internet, or other suitable communications network, using any portable or non-portable terminal with data networking capabilities, such as a personal computer 150, a laptop 152, a personal digital assistant 154, mobile phone 156, or increasingly hand-held entertainment consoles (not shown). The server 140 has access to a number of systems, such as a transaction processing facility or module 142, accounts processing facility or module 143, delivery processing facility or module 144, registration processing facility or module 145, advertisement processing facility or module 146 and messaging facility or module 147, and other services facility or module. The functionality embodying these may be provided as computer code stored at the server 140, or at the server 140 and other servers on a local or remote network, such as the Internet. The website acts a user interface for a buyer or seller to define a transaction.

The web site has a home page from which users can register their details, log-in, and create and manage transactions with third parties. In the example embodiment, the web site also has a facility that allows users to post classified advertisements, or offers for sale, and that allows other users to respond with a bid. It is envisaged however that the majority of buyers and sellers using the web site will have already made contact with each other before they log-in (by responding in the conventional way to advertisements placed in other channels for example), and will use the web site primarily as a means for arranging secure payment and safe negotiation before the transaction is completed.

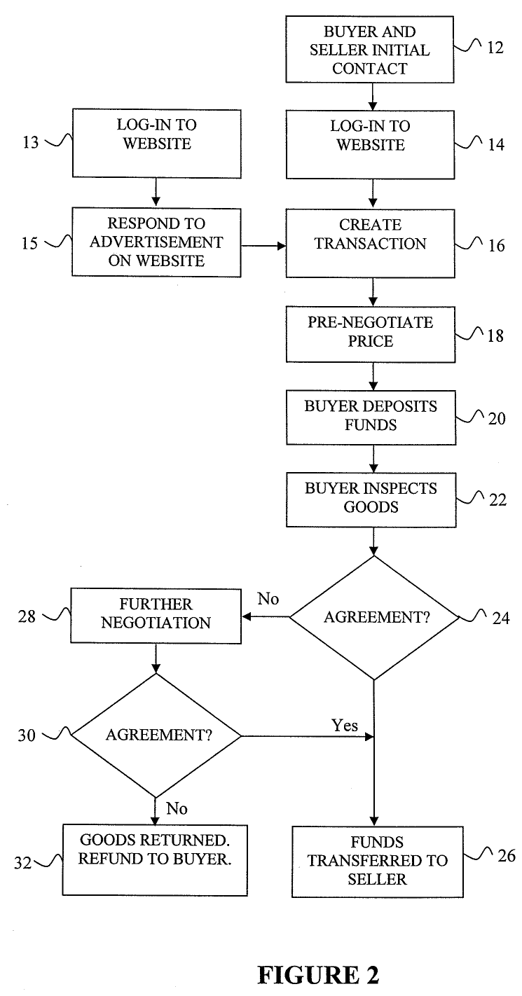

Reference should now be made to FIG. 2, which is a flow chart illustrating at a high level the general stages of the transaction facility provided by an example implementation of the invention.

As with any transaction, the first stage is for the buyer and the seller to find each other (step 12) and communicate their interest in making a sale. The functionality provided by the web site is primarily concerned with how to complete the transaction itself, and it does not therefore matter how the buyer and seller become aware of each other and the goods on offer. In particular, the web site provides a number of web pages, web forms and monitored time-sensitive processes that allow a buyer and seller to create a description of the transaction that they are proposing to make, and have the transaction managed for them. The term “transaction management system” shall be used herein to refer to the various items of control software stored on the one or more servers and embodying the transaction process and front end graphical user interfaces (web site, web pages and web forms).

Steps 12, 14 and 16 of FIG. 2 therefore represent the situation in which a buyer and seller have found each other through traditional means, such as word-of-mouth, advertisement in a publication or broadcast medium, and have tentatively agreed to make a sale using the web site and example transaction management system. It is preferred if both the buyer and the seller are registered with the web site, as in this way address, contact and bank details can be verified and stored, providing security for both buyer and seller alike. In step 14, therefore, the buyer or seller log on-to the web site using pre-agreed personal identifiers and password, and in step 16, the buyer or seller use the web site to manually create and structure the transaction. This will be described in more detail in subsequent sections of this description.

Steps 13, and 15 represent an alternative scenario also possible with the web site, where a registered user logs-in to the web site to view (in step 15) advertisements posted by registered third parties. In this scenario, the web site provides the benefits of a combined advertisement and payment site. On selecting an advertisement of interest, the web site is preferably configured to automatically create at least part of the transaction (step 16) for later stages. This is straight forward as, having access to the details of the advertisement, the web site can map at least some of these across to an appropriate transaction. It will be appreciated that the advertisement facility represented by steps 13 and 15 is not essential to the operation of the web site, and so can be included or omitted as required in any particular implementation.

In step 16, the buyer or seller enter their details, and the details of the transaction that is to take place via the web site. As explained in more detail later, the transaction management system uses this information to create the necessary logical data structures for:

1) encapsulating the transaction as a time-sensitive process with corresponding deadlines;

2) representing the transaction and the progress of the transaction visually via the web site with subsequent web pages and web forms for data entry and interaction, and

3) creating and issuing communications, preferably electronic to instruct or notify the buyer and seller of progress or the next action that they should take.

A key feature of the transaction process is that the buyer and seller have opportunities during the transaction process to negotiate further. Thus, once the buyer and seller have logged-in to the web site and the step of creating the transaction is underway, the buyer and seller have an opportunity, regardless of the details of any existing advertisement or agreement, to confirm the price of the sale or negotiate a new price (step 18). The price agreed in this step will be the initially proposed sum for the transaction and in step 20 the buyer is required to deposit this amount of funds (plus any service charges) before the transaction can continue. In this way, the seller is assured that the buyer has allocated the funds.

For this purpose, the example implementation of the invention provides a secure bank account as part of the account processing facility 143 into which users of the web site acting as buyers can deposit funds for the transaction management system to hold in trust. Transfer of the funds to the seller (or to the buyer, in the case of a refund) can then be initiated by the transaction management system at a later appropriate stage in the transaction. Payment into or from the secure bank account can be made in any conventional way such as by cheque or electronic transfer between designated bank accounts. It is preferred if each user of the web site has a personal account provided by the web site for making purchases and receiving funds from sales. Such accounts can be allocated as part of the registration process, and are advantageous from an operational point of view, as regular users of the web site can leave funds with the system for future purchases.

Once the funds are in place for the buyer, then depending on the transaction, the web site instructs the seller to forward the goods to the buyer for the buyer to inspect them, or the buyer and seller meet in person for inspection to take place (step 22). In the case of face to face meetings, the buyer is at this stage still protected as there is no requirement that they carry payment in person.

The transaction process then provides for a number of rounds of negotiation assisted by the web site. If the buyer is satisfied with the goods, then the buyer can in step 24 confirm to the transaction management system, using a portable data network connected device for example, that both parties are in agreement. The buyer can then have the transaction management system release the funds to the seller in step 26. For face-to-face meetings, this means that the buyer can take possession of the goods immediately, removing the possibility that the goods will continue to be used by the seller until payment is received at a later time or date.

If the buyer indicates that the goods are not acceptable (step 24), then the transaction process provided by the web site allows further negotiation (step 28) between buyer and seller. If they reach a subsequent agreement in step 30, resulting in a lower price, the seller must inform the web site of the agreement on the basis of the reduced price. The agreed funds are then released to the seller, and any refunds returned to the buyer, less processing charges.

On the other hand, if no agreement is reached, then after any goods have been returned to the seller by the buyer, and the seller has indicated that they are acceptable, the buyer's funds are reimbursed minus any transaction fees (step 32).

The transaction process will now be explained in more detail.

In terms of the example computer implementation of the invention, each type of transaction is implemented in software or machine readable instructions on the server 140. As discussed above, transaction data describing an actual or intended transaction is entered by the buyer or seller in step 16 and stored on the server. Part of that data necessarily indicates what type of transaction is to take place. There are two main types, namely Face-To-Face Transactions and Postal Transactions, and within each type further sub-types allowing customised transactions for particular goods. Otherwise, all transactions types have general properties and actions available to them.

When run by the server, the software or machine readable instructions interpret the data in order to present to the buyer and seller the necessary web pages and web forms according to that type of transaction, and monitor any time-sensitive deadlines.

In the example implementation, transactions are defined by one Base Transaction Type: “Transaction”, and two Extended Types: ‘Face-To-Face’ and ‘Postal’.

The Extended Types handle the way the system deals with things like time-limits on actions and any variations in process flow. The main difference between the Face-To-Face and Postal Transaction types is that Postal provides methods of indicating that the goods have been posted to the buyer (or seller in the case of returns), and monitors the time that they have been under inspection. It will also automatically close the transaction (and pay the seller) if the buyer does not indicate acceptance or rejection of the goods within a predetermined period of time.

In order to handle different types of goods, the example implementation provides description variables that define what information is required for each type of goods. The default description variable type provides a single line description for the goods, whereas the Auto Type, for example, provides the ability to enter a make, model, colour and registration of a vehicle. It should be noted that all descriptions ultimately resolve to a serialised object that can be stored in the Transaction data record as a string. This makes the system infinitely variable and scalable in terms of what types of goods that can be specifically catered for.

The process outlined in FIG. 2 will now be explained in more detail to illustrate the operation of the transaction management system. In step 40, it is assumed that the buyer has found an advertisement for an article or for goods that they wish to purchase, and in step 42 the buyer and seller have made contact and agreed to use the web site provided by the preferred system. Alternatively, the buyer may have seen an advert placed by the seller in a magazine or other medium, and may use the web site to contact the seller with a proposal to use the web site to conduct the transaction. As noted below, the seller will be notified of the transaction once the buyer has entered all relevant details, and may accept or decline.

In the following example, although for the purposes of discussion, it is the buyer that initiates the transaction process using the web site, it may equally be the seller. Therefore, the terms buyer and seller in steps 42 to 56 are interchangeable.

Thus, in step 44, if the buyer has not yet registered with the web site, they do so, entering personal information such as:
a) Contact details: (such as postal, email address, contact telephone number).
b) Payment details (e.g. nominated bank account for any electronic transfer or refunds)

The registration processing facility operates to present the user with the appropriate web forms to register. It also allocates, in conjunction with the account processing facility 143, personal log-in details and an account number for handling payment. Either the registration facility or the account facility may be implemented to check the validity of any information entered by the user.

Once registered and logged-in, the buyer in step 46 selects the appropriate buttons or menu options from the home page to create a new transaction. The transaction to be created may be selected as a general transaction type, thereby presenting the buyer with a web page for entering all of the details necessary to fully describe the transaction. Alternatively, the home page may present buttons or menu options for specific transaction types. A particular transaction type, the Auto type, provided by the web site is for the sale of vehicles such as automobiles, as such transactions often are complicated by the need to consider insurance, certificates of road-worthiness, vehicle history and so on. Prompts for the seller to produce any necessary documents, and for the buyer to confirm that such documents are in order, can therefore be modelled as key steps or gates in the transaction along with corresponding time checks. Alternatively, the web site may link to other web sites displaying information about the goods on offer, reviews, valuation details and so on. The Parker's and Glass's web sites for example both provide information about vehicles, and links to these pages could be provided as part of the any transaction for vehicles, once the details of the vehicle have been entered by the buyer or seller.

The buyer will then be presented with a form requesting the details of the Transaction to be entered. Features include:

a) The e-mail address of the other party.

b) The description of the goods.

c) In the event that this is a vehicle, a make/model, colour and registration number are required.

d) For any other type of Goods a simple, single line description field will be supplied.

e) The proposed price of the purchase.

f) Whether or not the price is negotiable

g) Whether the transaction will completed in person or via courier

In connection with point f), transactions are intended to always be negotiable by the seller. A seller will be able to adjust the price of the item at any time once funds have been allocated to the transaction. In this event, the transaction management system will pause the transaction and send an email to the buyer asking him to confirm the new amount. The buyer will not be able to complete the transaction before accepting the renegotiation.

Assuming the buyer has entered the information noted above to create the transaction, the form displayed on the screen is updated automatically (in the example, Javascript is used and should therefore also be enabled on the buyer's browser) to show the service fee that will be due for the transaction, and the total amount that will need to be deposited in order to pay the seller and pay the service fees. It is intended that the service fee for a transaction will always be paid by the buyer, though in alternative examples this maybe negotiable between the buyer and seller.

If Javascript is not enabled on the buyer's browser, the form will still work, but won't automatically update. In this case, a warning message will display explaining why it doesn't update and reassuring the buyer that they will be informed of any fees due before they commit to the transaction.

The buyer submits the information using the web form, and the web site validates that the information supplied is sufficient to process the transaction.

If the validation passes, the buyer is presented with a confirmation page. This page will include the transaction details he has entered and the fee that will be due and also advise on the total amount that will need to be deposited in order to pay for the transaction (and associated fees). The page will also provide a window for the buyer to read the terms and conditions for the transaction, and that requires the buyer accept the conditions before they can proceed. These may differ to the terms and conditions for using the site, which the buyer will have had to accept at registration.

If the validation fails, the buyer will be presented with a message explaining why, and a button to return to the form to make adjustments. If any parts of the submission need to be changed, the buyer can return to the form with the fields containing his previous entries.

Once the buyer has confirmed his submission, a transaction will be created and an email will be sent to both parties (step 48). The buyer will receive via email a confirmation email containing a record of all the details entered. The seller will receive an email in step 48 that:
1) invites him to register with the site if he is not already registered with the site, and
2) provides a link through to the page where he can accept or decline the transaction. This page preferably requires the seller to log in or register with the site if they have not already done so.

The seller therefore registers (if necessary) in step 50, and views the web page setting out details of the transaction as entered by the buyer.

On this page, if the transaction has been marked as negotiable by the buyer, then the seller will be able to adjust the amount proposed before accepting, and have the web site recalculate the fees as appropriate.

The seller accepts the transaction (step 52), as proposed or as amended, by clicking on an appropriate button or option on the web page. An email is then sent to the buyer notifying him of the seller's initial acceptance of the transaction, and if the price has been modified, notifying him of the seller's counter offer. A flag is set in the system to indicate the seller has accepted the transaction.

If the seller has not modified the price proposed by the buyer, then the process flow leaps to step 56, representing the acceptance of the transaction by the seller. The buyer then receives the email, and is instructed to deposit funds for the transaction to go ahead (step 58).

For good measure, the instructions may require the buyer to confirm acceptance of the transaction, by clicking on a link in the email or logging in to the web site. The buyer at this stage is preferably given an opportunity to negotiate the price. This allows the buyer to negotiate before seeing the goods or having the goods delivered if, for example, the buyer does not think the price is reasonable. The entering of the price as part of the transaction definition is therefore not necessarily indicative of an agreement of a price between the buyer and seller, and may simply be the seller's originally proposed price. This allows the transaction definition stage to be conducted without any preliminary negotiations being concluded, which is useful from a procedural point of view. Also, if the buyer has changed his mind before receiving the seller's acceptance, the facility for the buyer to confirm is useful as it allows the buyer to pull out and have notification automatically sent to the seller.

If in step 52, the seller adjusts the amount of the transaction, then a flag is set in the transaction to indicate that the seller has accepted the transaction, and a second flag is set to indicate that the buyer has yet to accept the modified transaction.

The process flow then proceeds to step 54, wherein an email is sent to the buyer to advise him of the change in the proposed price. In the example, the email contains a link to the acceptance page as before. The buyer has the same options as the seller in the previous step: either to accept the transaction as proposed, or to adjust the amount and enter further negotiation.

If the buyer opts to adjust the amount in step 54, then in identical but opposite fashion to before, an email is sent to the seller indicating the new price and requesting that the seller confirm this acceptable. A flag is set in the transaction to indicate that the buyer has accepted the transaction, and a second flag is set to indicate that the seller has yet to accept the modified transaction. This process of negotiating can in theory continue backwards and forwards indefinitely, as the aim is to allow the buyer and seller to begin at their preferred prices and move towards a compromise position which is acceptable to them both. However, as at this stage of the process, the buyer has not yet had the opportunity to inspect the goods it is preferred if the number of negotiating rounds is kept to a minimum. The web site may therefore limit the buyer and seller to say only one or two opportunities to negotiate on the price, before requiring both parties to accept and the buyer to deposit the money for the purchase.

At any time, if one party rejects a newly proposed price, the web site will notify the other side of the rejection, and ask if the refused party wishes to continue with the transaction at the last proposed price.

Once the parties to the transaction have agreed the price, the buyer will be required to deposit the funds to cover the agreed price and any transaction fees, such as a service charge and shipping fees. The buyer having clicked on the email, will be taken to a page inviting him to either allocate funds to the transaction from the personal account provided by the system (assuming sufficient funds are available) or, if necessary, obtain the information needed to deposit funds to the personal account for later use.

Once funds have been allocated to the transaction, the status of the transaction will be set appropriately and an email will be sent to both parties confirming subsequent steps that are required.

If the transaction is of the Postal type, the seller will be receive an email instructing him to post the goods and provide a link to a page where he can supply tracking information to the Buyer. The Buyer will receive an email confirming his funds have been allocated.

If the Transaction is a Face-to-Face type, both Parties will receive an email informing them that they should arrange to meet. The web site can take the opportunity to promote any associations or services it feels are relevant at the same time.

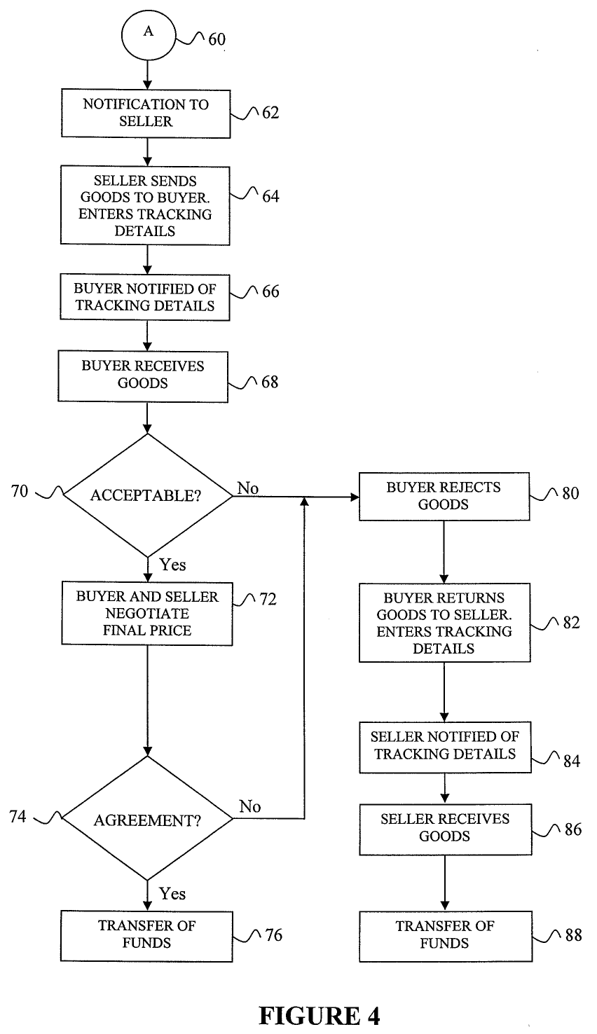

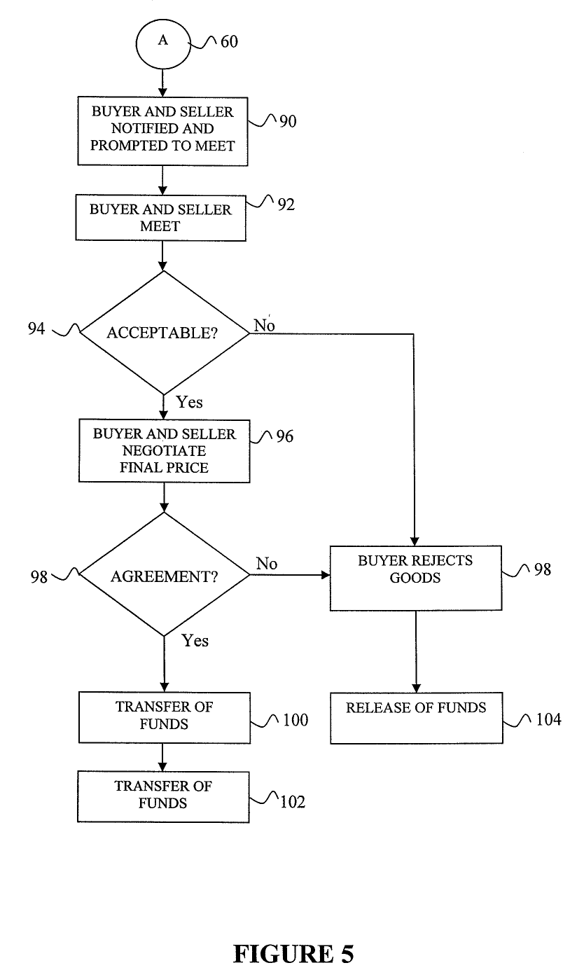

From here (step 60), the processes fork. The subsequent steps specific to the postal transaction type will be described with reference to FIG. 4, and the subsequent steps specific to the Face to Face transaction type will be described with reference to FIG. 5.

### Postal Transaction Type

As soon as funds are allocated, the web site sets the transaction to show a status of “Dispatch Goods” and sends an email (step 62) to the seller requesting that the seller have the goods delivered to the buyer by courier or other trusted delivery service. The email further contains a link to a web page inviting the seller to enter tracking details for the parcel once it has been entrusted to the delivery service.

Having logged onto the web page, the seller should provide at least the following:

1) The service used. In the example, the web site provides a drop down list of key services and an “other” option for which the user will need to provide the Service Name, and a Service Web site URL

2) The Tracking/Consignment Number (preferably, this requires a validation override for 1st class post etc.)

In this example, the delivery service may be a third party delivery service, or may be a dedicated delivery service provided as part of the invention to users of the web site. The necessary processes, data structures and other infrastructure required to implement the delivery service are illustrated as Delivery Processing facility 144 in FIG. 6.

Having submitted the tracking details, the web site updates the status of the transaction to “Goods In Transit”. An email is then sent to the buyer to indicate that the goods have been dispatched (step 66).

The web site monitors the time that has elapsed since the transaction entered the ‘Goods in Transit’ stage, and sets a time limit for the goods to be delivered and received by the buyer (step 68). This might be 7 days for example.

In step 70, the buyer is required to acknowledge that the goods have been received, and acknowledge that they are acceptable. They do this by either sending an email to the site, or by logging onto a web page provided by the site for this purpose. As the time limit of seven days approaches, the web site may issue a reminder to the buyer that an acknowledgement is needed.

If the buyer has not acknowledged receipt of the Goods by the time limit, then in the example, the transaction is put on hold and is flagged for intervention by an operator, so that follow up action can be taken. The follow up action will vary depending on the circumstances. For example, if the tracking service can confirm that the goods were successfully delivered to the buyer, then the follow-up action might be payment to the seller, and notification to the buyer of the action taken. If the tracking system cannot confirm delivery of the goods, then the operator may contact the buyer and seller to advise that situation is being investigated.

Acknowledgement does not mean that the buyer agrees to close the transaction at that point and pay the agreed price. It simply means that the buyer has received the goods, and is interested in proceeding with the transaction either at the agreed price, or at a negotiated price to be agreed in a subsequent step. If the buyer refuses the goods in step 70, for example if they are damaged or not what the buyer expected, then the process flow jumps to step 80. The process from step 80 onwards is described below.

Having acknowledged receipt of the goods, and that the goods are broadly acceptable, the buyer then has an inspection period of two days to inspect the goods and either accept, reject or re-negotiate the price with the seller.

If two days passes and the buyer has neither accepted nor rejected the goods, the buyer will have been deemed to have accepted the goods, and the transaction will automatically be completed (leaping to step 76). This will automatically pay the seller and deduct any fees for the transaction from the buyer. If within the two days, the buyer decides to reject the goods, then the process flow jumps to step 80 as above.

Having received the goods for inspection, the buyer has the opportunity to renegotiate the price (step 72). This is a key feature of the transaction process, and gives the buyer both the flexibility and security when purchasing goods sight-unseen.

In step 72, the buyer should contact the seller directly and to agree a new amount. Such contact may be made by any means such as telephone, email, text message, or instant messaging service.

The seller is then required to log in to the site and amend the amount agreed in the transaction. As noted above, in the preferred example the seller can adjust the price of the transaction at any time, whereas the buyer is limited to the initial negotiations only. An email is then sent to the seller confirming the adjustment and a second email sent to the buyer confirming the adjustment and asking the buyer to login to the site to confirm acceptance or rejection.

If the buyer declines the renegotiation (step 74), the status of the transaction will be set back to ‘Goods Under Inspection’ and the two parties are invited to talk again. An email will be sent to the seller advising him that renegotiation was declined. This scenario is unlikely as the two parties should already be in agreement at this stage, but does cover the unlikely event that the seller has simply increased the price without warning or the more likely event that the wrong amount was inadvertently entered—an extra zero for example.

If the buyer accepts the goods (step 74), this will complete the transaction, pay the seller, and deduct any transaction fees that are due. An email is then sent to both parties thanking them for using the web site.

If the goods are at any time rejected by the buyer, control flows to step 80. In step 80, the buyer has rejected the goods and is now required to return them to the seller. The buyer will need to supply a reason for the rejection, which the web site will pass on to the Seller, and confirm that the goods are being rejected. The buyer will also need to supply shipping information in the same way that the Seller had to on dispatch, and enter this into the web site (step 82).

In step 84, an email is sent to both Parties advising that the goods were rejected, and confirmation of the tracking details is sent to the seller (step 84). Again, a time limit is set for the seller to acknowledge receipt of the goods, and that they were received in an acceptable condition.

Once the goods have been received by the Seller (step 86), the seller is required to log on to the system to indicate that the goods have been received, and all is well. Once this occurs, any funds can be released to the buyer (step 88) minus any cancellation fees or transaction fees. If the seller indicates that there is a problem with the goods received from the buyer, then the transaction is put on hold and flagged for intervention by an operator.

The transaction management system therefore allows both buyer and seller to confidently enter transactions and negotiate with one another safe in the knowledge that they are not taking any risks associated with payment for the goods or the goods themselves.

### Face-to-Face Transaction Type

The steps of the face-to-face process are similar to the postal transaction type but incorporate process checks to allow buyer and seller to meet. As soon as funds are allocated (step 60), the web site sets the transaction to show a status of “Goods Under Inspection” and an email is sent to both parties advising them to arrange the meeting (step 92). The web site may set a deadline of say a month for the meeting to occur and for the buyer to accept, before both sides are prompted to accept or refuse the transaction. However, this stage of the transaction does not need to be limited to any particular time period.

While the transaction is in the ‘Goods Under Inspection’ phase, renegotiation of price can take place as per the Postal Transaction Type. It is more likely to be done while the two parties are together, thereby reducing the risk of error or misunderstanding.

As before, the buyer has on opportunity to reject the goods outright, if they are not what was advertised or if they are damaged in any way for example (step 94). As before, if the buyer rejects the goods, the buyer should enter a reason (which can be fed back to the Seller) and confirm that the goods are being rejected (step 98). The transaction will be completed and funds will be returned to the buyer (minus any cancellation fees) in step 104.

If on meeting the buyer, the goods are broadly acceptable, then the buyer and seller can negotiate as before (step 96) and agree a final price. The seller should enter the new price into the system triggering the same sending of emails as before, and the requirement that the buyer confirm the new price.

If the buyer accepts the original or negotiated price of the goods, then the transaction will be completed, the seller will be paid, and any transaction fees will be deducted from the buyer's account. A confirmation email will be sent to both parties.

### Additional Stages

As noted above, on of the transaction types made possible by the invention is an ‘Auto’ transaction type, specific for the sale of vehicles. This transaction introduces a number of additional checks and stages into the process flow, as follows:

1) In one example, the seller may be invited to deposit or forward to the buyer copies of road worthiness certificates, valuation certificates and ownership certificates for the vehicle before the transaction can continue. This stage may occur for example, after the buyer has entered the initial details of the transaction in step 46, and before the pre-negotiation step 54. Alternatively, it could also occur at step 90 when the buyer and seller are prompted to meet for inspection of the goods. The seller may actually be required to forward copies of the relevant documents to the buyer, or scanned copies may be made available on the web site for viewing. If documents are not provided within a specified period of time, or are not acceptable to the buyer, then the transaction should terminate.

2) For vehicle transactions, test drive insurance may be made available to the buyer for the meeting. Offering such insurance can be made possible as any payment can be taken from the buyer's account.

3) In the case of face-to-face transactions, the transaction management system can also provide human support at the point buyer and seller meet. This option, called “escorted trade” is made available to buyer and seller as part of the transaction definition and creation process. If interested, buyer and seller must request the service, by ticking a box or selecting an option on a form, and likely agree to incur a fee. If selected, a human operator will be available to meet with the buyer and seller at the face-to-face meeting to assist.

The example transaction management system described allows the buyer and seller to manage all of their transactions from one site in complete security, dealing remotely or face-to-face. Regular users can operate and manage multiple transactions with the transaction management system providing an on going trading account with full transaction history. Although the transaction management system is targeted at private individuals who trade via classified and auction sites, it will be appreciated that it may also support the sale of goods or services, such as property, travel arrangements, holidays, tradesmen, investments and so on. The transaction management system can operate in real time providing a secure facilitation process between buyer and seller.

The foregoing descriptions of embodiments of the present invention have been presented only for purposes of illustration and description. They are not intended to be exhaustive or to limit the present invention to the forms disclosed. For example, although the use of emails has been described as the preferred means of communication between the web site and the buyer and seller, other types of messages could be used such as SMS text messages, video or audio messages, VOIP messages, text-based instant messaging, or indeed any means of communication between people. In alternative examples, the web site itself may provide an instant messaging facility so that if both buyer and seller are on-line they can communicate with each other, or a notice board facility for buyers and sellers to post messages to each other when the other is off-line. Instructions could also be received by telephone call to an operating service, human or automatic.

The skilled person will also appreciate that all references to software or computer code are intended to include hardware.

In alternative examples of the invention, it is not necessary that the graphical user interfaces be implemented via a web site. An application for download to or installation on a user's computer or mobile terminal could be provided to implement the front end forms and graphical user interfaces. Any data input into the application could then be sent via network to the back end processing stages.

Accordingly, many modifications and variations will be apparent to practitioners skilled in the art. The scope of the present invention is defined by the appended claims.

What is claimed is:

1. A computer implemented method of conducting a transaction between a buyer and a seller, comprising the steps of:
receiving an initial input from the buyer or the seller to define the transaction, the transaction specifying a transaction type, a goods or a service being sold in the transaction, and a proposed price for the goods or the service;
creating a representation of the transaction in memory;
depending on the transaction type, establishing and monitoring deadlines associated with different stages of the transaction, notifying the buyer or the seller of actions that should be taken before the deadlines, and requesting confirmation from the buyer or the seller of any actions taken;
requesting payment from the buyer for the proposed price of the transaction, and on receiving payment from the buyer, storing payment in an account associated with at least the buyer;
depending on actions being taken, or not taken, by the buyer or the seller before the deadlines established in connection with different stages of the transaction, progressing through the stages, and eventually completing the transaction and paying the seller from the account associated with at least the buyer, or not paying the seller; and
wherein a number of different transaction types can be specified by the buyer and the seller, and each type has different transaction stages and associated deadlines.

2. The computer implemented method of claim 1, wherein the transaction types include at least a face-to-face transaction type having a transaction stage in which the buyer and the seller are encouraged to meet, and a postal type having a transaction stage in which the seller must forward the goods to the buyer for inspection.

3. The computer implemented method of claim 1, wherein the transaction types include a negotiable transaction type in which at least one of the buyer and the seller have at least one opportunity after the representation of the transaction has been created in memory to re-negotiate the proposed price of the goods or the services, the method further comprising:
in response to an input from the buyer or the seller proposing a new proposed price, pausing the transaction;
notifying the other of the buyer or the seller of the new proposed price; and
requiring the other of the buyer or the seller to confirm that the new proposed price is acceptable before the transaction can resume, or allowing the other of the buyer or the seller to make a counter offer or decline.

4. The computer implemented method of claim 3, wherein the at least one opportunity for the buyer, is after the buyer has viewed the goods or the services.

5. The computer implemented method of claim 4, wherein the buyer has a further opportunity after the representation of the transaction is created in memory to input a new proposed price for the goods or the services.

6. The computer implemented method of claim 3, wherein the buyer has no further opportunity to negotiate the proposed price.

7. The computer implemented method of claim 3, wherein, the seller can, at any time after the representation of the transaction is created in memory, and before the transaction is completed, input a new proposed price for the goods or the services.

8. The computer implemented method of claim 3, wherein if the other of the buyer or the seller inputs a proposed price by way of counter offer, the buyer or the seller is required to accept the counter offer before the transaction can resume, or make a further counter offer.

9. The computer implemented method of claim 1, further comprising, in dependence on the input transaction type, offering the buyer or the seller further services in connection with the transaction, such services including delivery services for delivering goods, tracking services for tracking the delivery of goods, and insurance services.

10. The computer implemented method of claim 1, further comprising requiring the seller to input, for transactions involving goods, one or more of a proof of ownership of the goods, a report indicating a value of the goods, a report indicating a condition of the goods, or a link to other sources of information providing information about the goods for the buyer and the seller.

11. The computer implemented method of claim 1, further comprising providing personal account details to the buyer and the seller.

12. The computer implemented method of claim 1, wherein input of transaction details, and notification to the buyer or the seller is by one or more of input via web site, email, text message, telephone, video or audio message, or instant message.

13. A computer readable medium on which computer code is stored, said computer code when executed by a computer processor, causing the processor to carry out the following steps for conducting a transaction between a buyer and a seller:
receive an initial input from the buyer or the seller to define the transaction, the transaction specifying a transaction type, a goods or a service being sold in the transaction, and a proposed price for the goods or the service;
create a representation of the transaction in memory;
depending on the transaction type, establish and monitor deadlines associated with different stages of the transaction, notify the buyer or the seller of actions that should be taken before the deadlines, and request confirmation from the buyer or the seller of any actions taken;
request a payment from the buyer for the proposed price of the transaction, and on receiving the payment from the buyer, storing the payment in an account associated with at least the buyer;
depending on actions being taken, or not taken, by the buyer or the seller before any deadlines pass, progress through the stages, and either i) complete the transaction and pay the seller from the account associated with at least the buyer, or ii) abandon the transaction and not pay the seller; and
wherein a number of different transaction types can be specified by the buyer and the seller, and each transaction type has different transaction stages and associated deadlines.

14. The computer readable medium of claim 13, wherein the transaction types include at least a face-to-face transaction type having a transaction stage in which the buyer and the seller are encouraged to meet, and a postal type having a transaction stage in which the seller must forward the goods to the buyer for inspection.

15. The computer readable medium of claim 13, wherein the transaction types include a negotiable transaction type in which at least one of the buyer and the seller have at least one opportunity after the representation of the transaction has been created in memory to re-negotiate the proposed price of the goods or the services, and wherein the computer code when executed by the computer processor causes the processor to carry out the following steps:
in response to an input from the buyer or the seller proposing a new price, pausing the transaction;
notifying the other of the buyer or the seller of the new proposed price; and
requiring the other of the buyer or the seller to confirm that the proposed price is acceptable before the transaction can resume, or allowing the other of the buyer or the seller to make a counter offer.

16. The computer readable medium of claim 15, wherein the at least one opportunity for the buyer, is after the buyer has viewed the goods or the services.

17. The computer readable medium of claim 16, wherein the buyer has a further opportunity after the representation of the transaction is created in memory to input a new proposed price for the goods or the services.

18. The computer readable medium of claim 15, wherein the buyer has no further opportunity to negotiate the proposed price.

19. The computer readable medium of claim 15, wherein, the seller can, at any time after the representation of the transaction is created in memory, and before the transaction is completed, input a new proposed price for the goods or the services.

20. The computer readable medium of claim 15, wherein if the other of the buyer or the seller inputs a proposed price by way of counter offer, the original party of the buyer or the seller is required to accept the counter offer before the transaction can resume, or make a further counter offer.

21. The computer readable medium of claim 13, further comprising, in dependence on the input transaction type, offering the buyer or the seller further services in connection with the transaction, such services including delivery services for delivering goods, tracking services for tracking the delivery of goods and insurance services.

22. The computer readable medium of claim 13, further comprising requiring the seller to input, for transactions involving goods, one or more of a proof of ownership of the goods, a report indicating a value of the goods, a report indicating a condition of the goods, or a link to other sources of information providing information about the goods for the buyer and the seller.

23. The computer readable medium of claim 13, further comprising providing personal account details to the buyer and the seller.

24. The computer readable medium of claim 13, wherein input of transaction details, and notification to the buyer or the seller is by one or more of input via web site, email, text message, telephone, video or audio message, or instant message.

25. A system for conducting a transaction between a buyer and a seller, comprising:
a processor for processing data input by the buyer and the seller and for taking action in dependence on the data, the processor communicating with:
a transaction definition user interface for receiving an initial input from the buyer or the seller to define a transaction, the transaction specifying a transaction type, a goods or a service being sold in the transaction, and a proposed price for the goods or the service; the processor creating a representation of the transaction in memory based upon the initial input;
a transaction processing module for, depending on the transaction type, establishing and monitoring deadlines associated with different stages of the transaction, notifying the buyer or the seller of actions that should be taken before the deadlines, and requesting confirmation from the buyer or the seller of any actions taken; and depending on actions being taken, or not taken, by the buyer or the seller before any deadlines established in connection with the different stages of the transaction, progressing through the stages, and eventually completing the transaction and paying the seller from an account associated with at least the buyer, or not paying the seller; and
an account processing module for requesting payment from the buyer for the proposed price of the transaction, and on receiving payment from the buyer, storing payment in the account associated with at least the buyer,
wherein a number of different transaction types can be specified by the buyer and the seller using the transaction definition user interface, and each type causes the transaction processing module to establish and monitor different associated deadlines reflecting different transaction stages.

26. The system of claim 25, wherein the transaction types include at least a face-to-face transaction type having a transaction stage in which the buyer and the seller are encouraged to meet, and a postal type having a transaction stage in which the seller must forward the goods to the buyer for inspection.

27. The system of claim 25, wherein the transaction types include a negotiable transaction type in which at least one of the buyer and the seller have at least one opportunity after the representation of the transaction has been created in memory to re-negotiate the proposed price of the goods or the services, wherein the transaction processing module is operable to:
in response to an input from the buyer or the seller proposing a new price, pause the transaction;
notify the other of the buyer or the seller of the new proposed price; and
require the other of the buyer or the seller to confirm that the proposed price is acceptable before the transaction can resume; or allowing the other of the buyer or the seller to make a counter offer.

28. The system of claim 27, wherein the at least one opportunity for the buyer, is after the buyer has viewed the goods or the services.

29. The system of claim 28, wherein the buyer has a further opportunity after the representation of the transaction is created in memory to input a new proposed price for the goods or the services.

30. The system of claim 27, wherein the buyer has no further opportunity to negotiate the proposed price.

31. The system of claim 27, wherein, the seller can, at any time after the representation of the transaction is created in memory, and before the transaction is completed, input a new proposed price for the goods or the services.

32. The system of claim 27, wherein if the other of the buyer or the seller inputs a proposed price by way of counter offer, the original party of the buyer or the seller is required to accept the counter offer before the transaction can resume, or make a further counter offer.

33. The system of claim 25, further comprising a delivery processing module, and a services processing module that are operable in dependence on the input transaction type, to offer the buyer or the seller further services in connection with the transaction, such services including delivery services for delivering goods, tracking services for tracking the delivery of goods and insurance services.

34. The system of claim 25, further comprising requiring the seller to input, for transactions involving goods, one or more of a proof of ownership of the goods, a report indicating a value of the goods, a report indicating a condition of the goods, or a link to other sources of information providing information about the goods for the buyer and the seller.

35. The system of claim 25, wherein the account processing module is operable to provide personal account details to the buyer and the seller.

36. The system of claim 25, wherein input of transaction details, and notification to the buyer or the seller is by one or more of input via web site, email, text message, telephone, video or audio message, or instant message.
